(19) United States
(12) Patent Application Publication
(10) Pub. No.: US 2023/0368044 A1
(43) Pub. Date: Nov. 16, 2023

(54) SYSTEM AND METHOD FOR AUTOMATICALLY SUGGESTING A FORMULA FOR A PRODUCT USING MACHINE LEARNING

(71) Applicant: PRODUCTDEV EDGE PVT. LTD, Bangalore (IN)

(72) Inventors: Simi Sugathan, BANGALORE (IN); Soumya Sugathan, BANGALORE (IN)

(21) Appl. No.: 18/195,881

(22) Filed: May 10, 2023

(30) Foreign Application Priority Data
May 10, 2022 (IN) 202241026981

(51) Int. Cl. G06N 5/022

(52) U.S. Cl. CPC G06N 5/022

(57) ABSTRACT

The embodiments herein relate to a system for automatically suggesting a formula for a product category. The system includes a user device, and a formula suggesting server. The formula suggesting server is configured to (i) obtain, by the user device, a primary formula and a desired function from a user or a first machine learning model (ii) suggest, by a second machine learning model, a list of related ingredients that have a causal relationship with the primary formula, (iv) processing a selection, of a second ingredient from the list of related ingredients by the user, to obtain a secondary formula that includes either a first ingredient or one or more ingredients, along with the second ingredient, (v) suggesting, using a third machine learning model, a concentration for the secondary formula that performs the desired function for the product category.

### CROSS-REFERENCE TO PRIOR-FILED PATENT APPLICATIONS

This application claims priority from the Indian provisional application no. 202241026981 filed on May 10, 2022, which is herein incorporated by reference.

### TECHNICAL FIELD

The present disclosure relates generally to a product lifecycle engineering and management platform, and more particularly, the present disclosure relates to an interactive product development system and method for suggesting a formula for a product category by generating and refining a primary formula using machine learning models.

### DESCRIPTION OF THE RELATED ART

Product development is the process of bringing a concept or an idea into a product to a market. Although the process of product development differs by industry, it may be divided into six stages: ideation, product definition, prototyping, refining, testing, and commercialization. The product development involves more than just creating a perfect formulation or recipe. Screening is the most critical step in product development which considers several factors that include financial and compliance, ingredient accessibility, shifts in market trends, consumer perceptions, safety, and stability. Furthermore, while developing the product from the idea, there may be several unprecedented challenges that may happen. Accordingly, the product development may incur high costs and consume more time for launch. The time spent on developing new products ranges from 6 months to 5 years, depending on the degree of new technology and innovation.

Developing products in industries such as cosmetics, food, textile, etc. is a laborious, costly, and time-consuming process. The product development involves extensive research to identify suitable ingredients, and the purchase of raw materials or ingredients and involves numerous trials, safety and compliance checks, and multiple rounds of testing.

Larger companies may rely on a product development team that includes scientists, engineers, regulatory specialists, marketing experts, etc. while smaller companies may not even have a research and development department. Smaller companies may rely heavily on outside resources, such as universities, external formulators, consultants, private labels, or independent laboratories to create successful products.

Some existing approaches provide a repository of scientific data on in-vitro and in-vivo results for cosmetic ingredients. However, the existing approaches need a toxicologist to assess the scientific data for the cosmetic ingredients and make them meaningful for product development.

Further, existing product lifecycle management (PLM) approaches help users with limited resources or data. These existing approaches are skill dependent and expensive for micro, small, and medium enterprises (MSME) and small and medium-sized enterprises (SME). Accordingly, in the existing approaches, gaps occur in terms of availing the right resources and scarcity of skilled people. In the case of large enterprises, development and finalizing a product is a five/ six department approval process leading to dependencies and often to and from processes between the formulator/development team and other teams. The existing systems do not have any automated system or technology to assist or enable the development team to minimize the back-and-forth communications and formula updates based on suggestions/comments from other departments.

Therefore, there arises a need to address the aforementioned technical drawbacks in existing technologies in accelerating product development.

### SUMMARY

In view of the foregoing, embodiments herein provide a processor-implemented method for automatically suggesting a formula for a product category based on a user preference and a desired function using machine learning models. The method includes (i) obtaining one or more ingredients with at least one desired function inputted by a user for a primary formula or at least one first ingredient selected by the user from a set of ingredients suggested by a first machine learning model for a primary formula, (ii) suggesting, by a second machine learning model, a list of related ingredients that have a causal relationship with the primary formula, the second machine learning model is trained based on causal relationships between features of historical ingredients or combinations of the historical ingredients, for a product associated with a product category, (iii) processing a selection of at least one second ingredient from the list of related ingredients by the user, to obtain a secondary formula that includes either the at least one first ingredient or the one or more ingredients, along with the at least one second ingredient, and (iv) suggesting, using a third machine learning model, a concentration for the secondary formula that performs the at least one desired function for the product category, the third machine learning model is trained by correlating the historical ingredients with historical concentrations and historical desired functions, thereby refining the primary formula.

In some embodiments, the set of ingredients is suggested by (i) receiving, using a user device, an input from the user, the input of the user includes a product category, at least one user preference, and the at least one desired function, (ii) determining, using the first machine-learning model, at least one primary function for the product category and suggesting the set of ingredients for the product category based on the at least one user preference and the at least one primary function to suggest the set of ingredients, the first machine learning model is trained by correlating historical products associated with historical product categories with the historical ingredients associated with the historical products, and (iii) processing the selection of the at least one first ingredient from a set of suggested ingredients, to obtain the primary formula that includes the at least one first ingredient.

In some embodiments, the method includes validating the primary formula by determining a performance rate of the primary formula based on the at least one user preference, a safety score, a stability index, a claim association, or an innovation index of the at least one first ingredient or the one or more ingredients of the primary formula by applying a fourth set of rules on the primary formula.

In some embodiments, the method further includes ranking the list of related ingredients that are matched with the primary formula based on the causal relationship with the primary formula.

In some embodiments, the method includes ranking the concentration of each ingredient in the secondary formula to perform the at least one desired function of the product category.

In some embodiments, the method includes refining the primary formula by suggesting the list of related ingredients using the second machine learning model if the performance rate of the primary formula is below a threshold level.

In some embodiments, the method includes refining the primary formula by suggesting the list of related ingredients using the second machine learning model if the at least one first ingredient of the primary formula is not relevant to the at least one user preference or if the user does not satisfy with the at least one first ingredient of the primary formula that is validated.

In some embodiments, the method includes validating, by applying the fourth set of rules, the secondary formula by determining the performance rate of the secondary formula based on the at least one of the user preference, the safety score, and the stability index, the claim association, and the innovation index of either the at least one first ingredient or the one or more ingredients, along with the at least one second ingredient.

In some embodiments, the method includes refining the secondary formula using the second machine learning model if the user is not satisfied with the secondary formula that is validated or if the performance rate of the secondary formula is below the threshold level.

According to the second aspect of the invention, a system for automatically suggesting a formula for a product category based on a user preference, and a desired function using machine learning models is provided. The system includes a formula suggesting server, a memory that stores a set of instructions, and a processor that executes the set of instructions. The formula suggesting server that obtains one or more ingredients with at least one desired function inputted by a user associated with a user device for a primary formula or at least one first ingredient selected by the user from a set of ingredients suggested by a first machine learning model for the primary formula. The processor is configured to (i) suggest, by a second machine learning model, a list of related ingredients that have a causal relationship with the primary formula, the second machine learning model is trained based on causal relationships between features of historical ingredients or combinations of the historical ingredients, for a product associated with a product category, (ii) process a selection, of at least one second ingredient from the list of related ingredients by the user, to obtain a secondary formula that includes either the at least one first ingredient or the one or more ingredients, along with the at least one second ingredient, and (iii) suggest, using a third machine learning model, a concentration for the secondary formula that performs the at least one desired function for the product category, the third machine learning model is trained by correlating the historical ingredients with historical concentrations and historical desired functions, thereby refining the primary formula.

In some embodiments, the processor is further configure to suggest by (i) receiving, using a user device, an input from the user, the input of the user includes a product category, at least one user preference, and the at least one desired function, (ii) determining, using the first machine-learning model, at least one primary function for the product category and suggesting the set of ingredients for the product category based on the at least one user preference and the at least one primary function to suggest the set of ingredients, the first machine learning model is trained by correlating historical products associated with historical product categories with the historical ingredients associated with the historical products, and (iii) processing the selection of the at least one first ingredient from a set of suggested ingredients, to obtain the primary formula that includes the at least one first ingredient.

In some embodiments, the processor is further configured to validate the primary formula by determining a performance rate of the primary formula based on the at least one user preference, a safety score, a stability index, a claim association, or an innovation index of the at least one first ingredient or the one or more ingredients of the primary formula by applying a fourth set of rules on the primary formula.

In some embodiments, the processor is further configured to rank the list of related ingredients that are matched with the primary formula based on the causal relationship with the primary formula.

In some embodiments, the processor is further configured to rank the concentration of each ingredient in the secondary formula to perform the at least one desired function of the product category.

In some embodiments, the processor is further configured to refine the primary formula by suggesting the list of related ingredients using the second machine learning model if the performance rate of the primary formula is below a threshold level.

In some embodiments, the processor is further configured to refine the primary formula by suggesting the list of related ingredients using the second machine learning model if the at least one first ingredient of the primary formula is not relevant to the at least one user preference or if the user does not satisfy with the at least one first ingredient of the primary formula that is validated.

In some embodiments, the processor is further configured to validate, by applying the fourth set of rules, the secondary formula by determining the performance rate of the secondary formula based on the at least one of the user preference, the safety score, and the stability index, the claim association, and the innovation index of either the at least one first ingredient or the one or more ingredients, along with the at least one second ingredient.

In some embodiments, the processor is further configured to refine the secondary formula using the second machine learning model if the user is not satisfied with the secondary formula that is validated or if the performance rate of the secondary formula is below the threshold level.

In another aspect, there is provided one or more non-transitory computer-readable storage mediums storing one or more sequences of instructions, which when executed by one or more processors, causes a method for automatically suggesting a formula for a product category based on a user preference and a desired function using machine learning models. The method includes (i) obtaining one or more ingredients with at least one desired function inputted by a user for a primary formula or at least one first ingredient selected by the user from a set of ingredients suggested by a first machine learning model for a primary formula, (ii) suggesting, by a second machine learning model, a list of related ingredients that have a causal relationship with the primary formula, the second machine learning model is trained based on causal relationships between features of historical ingredients or combinations of the historical ingredients, for a product associated with a product category, (iii) processing a selection of at least one second ingredient from the list of related ingredients by the user, to obtain a secondary formula that includes either the at least one first ingredient or the one or more ingredients, along with the at least one second ingredient, and (iv) suggesting, using a third machine learning model, a concentration for the secondary formula that performs the at least one desired function for the product category, the third machine learning model is trained by correlating the historical ingredients with historical concentrations and historical desired functions, thereby refining the primary formula.

### BRIEF DESCRIPTION OF THE DRAWINGS

The embodiments herein will be better understood from the following detailed descriptions with reference to the drawings, in which:

FIG. 1 is a block diagram that illustrates a system for automatically suggesting a formula for a product based on a user preference and a desired function using machine learning models, according to some embodiments herein;

FIG. 2 is a block diagram of the formula suggesting server that includes the first machine learning model of FIG. 1, according to some embodiments herein;

FIG. 3 is a block diagram of the formula suggesting server that includes the second machine learning model of FIG. 1, according to some embodiments herein;

FIG. 4 is a block diagram of the formula suggesting server that includes a third machine learning model of FIG. 1, according to some embodiments herein;

FIG. 5 is a block diagram of a quality analysis module of the formula suggesting server according to some embodiments herein;

FIG. 6 is a block diagram of an ingredient search engine of the formula suggesting server according to some embodiments herein;

FIG. 7 is a block flow diagram that illustrates a process illustrates a method of training machine learning models according to some embodiments herein;

FIG. 8 illustrates an exemplary multidimensional report of ingredients trends vs market trends vs product categories that is generated based on chemical data, health hazard data, and product category data, according to some embodiments herein;

FIG. 9 illustrates an exemplary user interface view of a selection of preferences by the user for generating the primary formula according to some embodiments herein;

FIG. 10A illustrates an exemplary user interface view of virtual prototyping of the formula suggesting server that suggest a set of ingredients for a primary formula based on the user preferences and a primary function of a product category, according to some embodiments herein;

FIG. 10B illustrates the exemplary user interface view of virtual prototyping of the formula suggesting server FIG. 10A that shows at least one first ingredient for the primary formula, according to some embodiments herein;

FIG. 11A illustrates an exemplary user interface view of virtual prototyping of the formula suggesting server that suggest a list of related ingredients for the primary formula, according to some embodiments herein;

FIG. 11B illustrates an exemplary user interface view of virtual prototyping of the formula suggesting server of FIG. 11A that shows at least one first ingredient and at least one second ingredient for the secondary formula according to some embodiments herein;

FIG. 12 is an exemplary user interface view of a dashboard of a virtual product prototyping of the formula suggesting server that suggests a concentration for the secondary formula based on a desired function according to some embodiments herein;

FIG. 13 illustrates an exemplary user interface view of a dashboard of the formula suggesting server of FIG. 1 that prompts a best formula for physical trials that is generated by machine learning models, according to some embodiments herein;

FIG. 14 is a flow chart that illustrates a method for automatically suggesting a formula for a product based on a user preference and a desired function using machine learning models, according to some embodiments herein; and

FIG. 15 is a schematic diagram of a computer architecture of a system or a user device or a formula suggesting server in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

As mentioned, there remains a need for an improved approach that overcomes technical drawbacks and delays in existing technologies in accelerating product development. Various embodiments disclosed herein provide an interactive system and a method for accelerating a product development by screening ingredients and prototyping products virtually using at least one machine learning model based on a given product specification and a primary formula, thereby reducing research time for ingredients, minimizing physical trials, minimizing uncertainties that potentially occur during the physical trials while evaluating a product and thus reducing time, cost and effort for developing the products. Further, the interactive product development system and method as disclosed in various embodiments herein evaluate the performance of the product by various factors that include individual ingredient safety rating, overall performance rate, stability index, safety rating, claim association, market trends, and innovation index, etc. based on the given product specification and the primary formula. Further, the interactive product development system and method generate a performance rate for the given product specification and the primary formula based on, but not limited to, formulation quality (e.g., stability index, performance rate), safety for health and environment and compliance, thereby enabling a user to understand the overall performance of a formula for developing the product. This 360-degree view predicts the probability of the performance of the formula and assists the user in effectively making decisions about which of those formulas need to be developed in a lab as part of the trails. Further, the interactive product development system and method as disclosed in various embodiments herein suggest one or more ingredients or suggest concentrations to refine the primary formula.

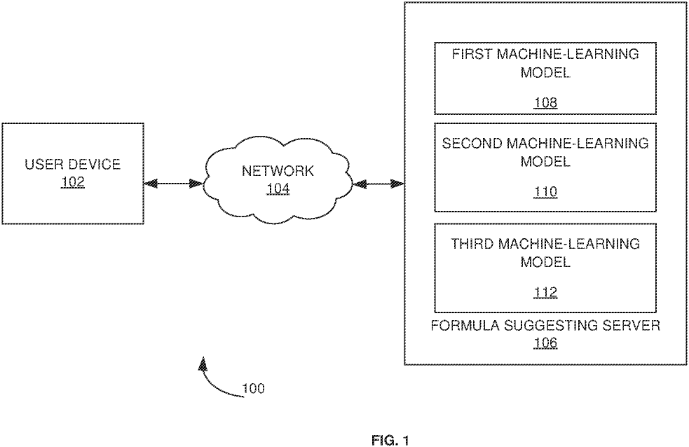

Referring now to the drawings and more particularly to FIGS. 1 through 15, where similar reference characters denote corresponding features consistently throughout the figures, there are shown preferred embodiments.

FIG. 1 is a block diagram that illustrates a system 100 for automatically suggesting a formula for a product based on a user preference and a desired function using machine learning models according to some embodiments herein. The system 100 includes a user device 102 and a formula suggesting server 106 that is communicatively connected over a network 104. The formula suggesting server 106 includes a memory that stores a set of instructions, and a processor that is configured to execute the set of instructions to perform one or more operations of the formula suggesting server 106. The formula suggesting server 106 includes a first machine learning model 108, a second machine model 110, and a third machine model 112. The formula suggesting server 106 may be configured to receive a registration request from a user for registering with the system 100 and may carry out ingredient research and virtual prototyping of products to reduce the number of physical trials and uncertainty before starting physical trials in a lab. The formula suggesting server 106 may be an online web platform or a mobile application.

The formula suggesting server 106 is configured to receive one or more inputs that include at least one ingredient, a primary formula, a recipe, ideation, a user preference, or a product specification, or the desired function for a product category, from the user associated with the user device 102. The input of the user is obtained through the user device 102 by displaying a set of questions on the display of the user device 102. The set of questions are, for example, “what is the product?”, “what is the product category?”, “what are the claims that are required for the product?”, or “What pricing strategy do you plan to use for this product?”. The user may provide the one or more inputs using an input unit through the user interface of the user device 102. The input unit may be a mouse, a keyboard, a microphone, a camera, a touchpad, a touch screen, or a joystick. The primary formula or recipe may include, but is not limited to, at least one of a list of ingredients, a concentration of each ingredient, a way to put the ingredients together to form a formula, or a function of each ingredient. The product specification may include but is not limited to, a product category, a product type, a use category, a physical form, color, texture, pH, viscosity, etc. The ideation may include an idea or concept for developing the product. The one or more inputs may include compliance check information. The one or more inputs may include one or more geographic zones or market areas that the product to be developed focuses on. The product category may be but are not limited to, a cosmetic product, a nutraceutical product, a pharmaceutical product, a food product or a beverage, any chemical product, a household product, a textile product, or toys. The user device 102 may include but is not limited to, a mobile phone, a kindle, a PDA (personal digital assistant), a tablet, a computer, an electronic notebook, a smartphone, or any computing device. Examples of the network 104 may include but are not limited to, a local area network (LAN), a wide area network (WAN), a public network, a private network, a proprietary network, the Internet, a wireless network, a virtual network, or any combination thereof.

The formula suggesting server 106 includes a product database and chemical database or a data warehouse that stores at least one ingredient or chemical data, health hazard data, environmental hazard data, market data, user data, or compliance or regulatory data. The ingredients/chemical data provide ingredient/chemical information/natural compounds that include but are not limited to, chemical/natural compounds by names, a molecular formula, structure, chemical, and physical properties, or biological activities.

The health hazard data provide information about chemical/natural compounds that are known to be hazardous to humans which include but are not limited to, carcinogens, genotoxic, reproductive toxins, developmental toxins, endocrine disruptors, irritants, corrosives, sensitizers, hepatotoxins, nephrotoxins, of neurotoxins. The environmental hazard data provide information about chemical/natural compounds that cause harm to environments such as air, water, or land. The market data may include but are not limited to, trending ingredients, trending products, market trends, and price of ingredients or products. The user data may include claims association, feedback about the performance of the ingredients, products, and availability of the product in the market. The compliance or regulatory data may include, but is not limited to, restricted chemicals, prohibited chemicals, a maximum threshold of chemical usage on country wise, label warnings, and use instructions. The desired function of the product or ingredient refers to a specific purpose for which it is added or incorporated into the formulation or recipe. The desired function determines a selection of appropriate ingredients and concentrations of the ingredients. The user preference may be but is not limited to, at least one use category, most preferred ingredients for an existing product, geographic zones or market area of the user, nature of an ingredient, safety information of the ingredients, market trends for the product category, or a number of ingredients.

The formula suggesting server 106 obtains one or more ingredients with the desired function inputted by the user for the primary formula through the user device 102 or the formula suggesting server 106 obtains the first ingredient selected by the user from a set of ingredients that is suggested by the first machine learning model 108 for a primary formula through the user device 102. The formula suggesting server 106 suggests a list of related ingredients that have a causal relationship with the primary formula by the second machine learning model 110, The second machine learning model 110 is trained based on causal relationships between features of historical ingredients or combinations of the historical ingredients, for a product associated with a product category. The causal relationships occur when attributes of an ingredient in the product database has a direct influence on another ingredient attributes. The formula suggesting server 106 processes a selection of a second ingredient from the list of related ingredients by the user to obtain a secondary formula. The secondary formula includes either the at least one first ingredient or the one or more ingredients, along with the at least one second ingredient. The formula suggesting server 106 suggests a concentration for the secondary formula that performs the at least one desired function for the product category using the third machine learning model 112,. The third machine learning model 112 is trained by correlating the historical ingredients with historical concentrations and historical desired functions. The formula suggesting server 106 performs refining the secondary formula until the performance rate is high or satisfied to the user, thereby reducing the number of physical trials for developing the product category.

The user may virtually refine the primary formula using the second machine learning model 110. The system 100 reduces the number of physical trials in the lab by performing virtual prototyping. The user may carry out several iterations virtually on the secondary formula. The user may further iterate the secondary formula to develop a new formula by including suggested alternative ingredients, concentration, etc. provided by the formula suggesting server 106 based on the user and market history and this will significantly reduce the time and effort spent on trials physically in the laboratories. In some embodiments, the formula suggesting server 106 is configured to predict the formula that has a high probability of the performance rate when developed physically in the lab, among the refined formulas based on, but not limited to, a stability index, innovation index, claim association, market trends, safety for health and environment and compliance.

The system 100 reduces the overall product development time upon various aspects such as reducing materials for trials, reducing hours of manpower, and time taken for the physical trials. The system 100 works as a hybrid AI model which combines cosmetic science rule-based logic and deep learning technology to deliver close to accurate physical development results. Cosmetic science rules involve a set of mandatory functions for a category of products followed by claims evaluation with a set of defined functions and unique ingredients. Along with the above analytically curated data derived from the cosmetic science rules and the machine learning models is presented as a set of rules.

In some embodiments, the formula suggesting server 110 also provides alerts to the user or admin user while using an application of the formula suggesting server 106. Similarly, the user may receive alerts if the user spends more time than required for product creation. The user may receive alerts if the user spends more than the allotted costs and so on. The formula suggesting server 106 may receive alerts when the user requests more product details such as safety data reports, ingredient reports, supplier details, and so on.

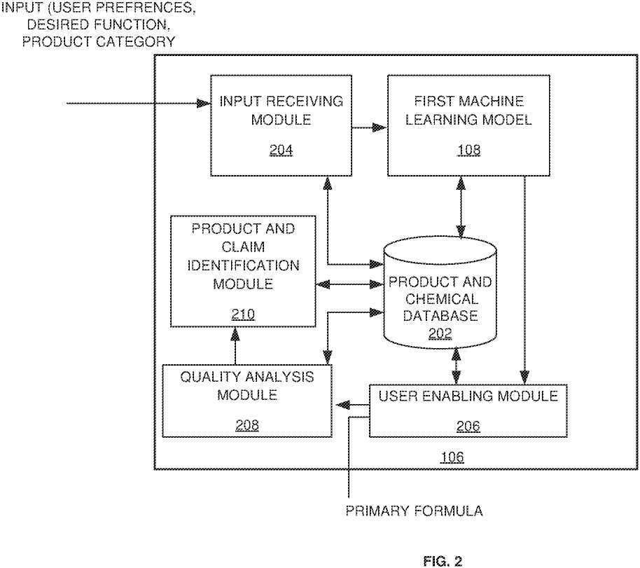

FIG. 2 is a block diagram of the formula suggesting server 106 that includes the first machine learning model 108 of FIG. 1, according to some embodiments herein. The formula suggesting server 106 includes a product and chemical database 202, an input receiving module 204, a user enabling module 206 a quality analysis module 208, a product and claims identification module 210 and the first machine learning model 108. The product and chemical database 202 the product database and the chemical database.

The product database includes product names, descriptions, prices, categories, brands, and other relevant attributes. The product database may also include information about availability of the products, ratings, and reviews of historical product data, and other related information, suppliers, manufacturers, and distributors of the products, the chemical data, the health hazard data, the environment hazard data, and the market data of each product, In some embodiments, the product and chemical database 202 may be externally present outside the formula suggesting server 106 and communicatively connected with the formula suggesting server 106.

The input receiving module 204 receives the one or more inputs from the user by a user device 102. The first machine learning model 108 determines a primary function for the product category. The first machine learning model 108 suggests the set of ingredients for the product category based on the user preference and the primary function. The primary function of a product category refers to a specific functionality of that particular product category. For example, for the product category of moisturizer, the primary function is smoothening the skin. Each ingredient for a product category provides a specific functionality or multiple functionalities. Each ingredient may serve multiple functions such as providing conditioning, protection, flavor, texture, color, nutritional value, or other functional properties. The first machine-learning model 108 is trained by correlating historical products associated with historical product categories with the historical ingredients associated with the historical products. The user enabling module 206 enables the user to select at least one first ingredient from the set of suggested ingredients, to obtain the primary formula.

In some embodiments, the first machine learning model 108 is configured to perform the ingredient search if the user does not provide a list of ingredients or the primary formula for the product in the one or more inputs. The first machine learning model 108 determines the primary function for the respective product category. Further, the user performs the ingredient search by (i) searching one or more ingredients in the product database 202 based on the at least one user preference or the ideation and product specification for the product category using deep learning techniques, (ii) providing the set of ingredients which are suitable for the primary formula or the ideation and the product specification based on one or more criteria and (iii) enabling the user to select the at least one first ingredient from the set of ingredients to obtain the primary formula. The one or more criteria includes, not limited to, the function or nature of an ingredient, regulatory compliance, safety information of the ingredients, market trends, ingredient trends for the product type and the product category, and the use category.

The quality analysis module 208 is configured to validate the primary formula by determining the performance rate of the primary formula based on the at least one user preference, the safety score, the stability index, the claim association, or the innovation index of the at least one first ingredient of the primary formula by applying the fourth set of rules on the primary formula. The formula suggesting server 106 is configured to perform the ingredient search in the product and chemical database 202 if the user is not satisfied with the primary formula that is validated.

In some embodiments, the quality analysis module 208 is configured to validate the one or more ingredients of the primary formula that is inputted by the user by determining the performance rate of the primary formula by applying the fourth set of rules on the primary formula.

In some embodiments, if the user is not satisfied with the primary formula that is validated, the formula suggesting server 106 is configured to perform the ingredient search in the product and chemical database 202. The formula suggesting server 106 is further configured to search one or more multifunctional ingredients or combined functionality for the given primary formula or the ideation and the product specification, thereby reducing the number of ingredients for developing the product and cost incurred for the additional ingredient.

The quality analysis module 208 is configured to provide performance scores or rates and feedback to the user about the primary formula. The score is calculated based on the fourth set of rules and provided to the user in the format of scores 1 to 10 or color code red (low), amber (moderate), and green (good). If the user is satisfied, then the primary formula is fed into the product and claim identification module 210. The product and the claim identification module 210 provides detailed information about the primary formula for the user to map against the claim association or the at least one user preferences given. The product and the claim identification module 210 provides information about the product in the form of performance rating that includes the claim association, the stability index, safety, the market trends, and the innovation index of the primary formula. If the user is not satisfied with the primary formula, the process of changing the formula and recommendation continues.

In some embodiments, if the user is satisfied with the primary formula, the second machine learning model 110 will not suggest any changes to the primary formula. However, if the user wants to improve the concentration of certain ingredients in the primary formula, the third machine learning model 112 can suggest adjustments to the concentrations based on the at least one user preference and the at least one desired function. This can help the user create a more personalized and effective supplement.

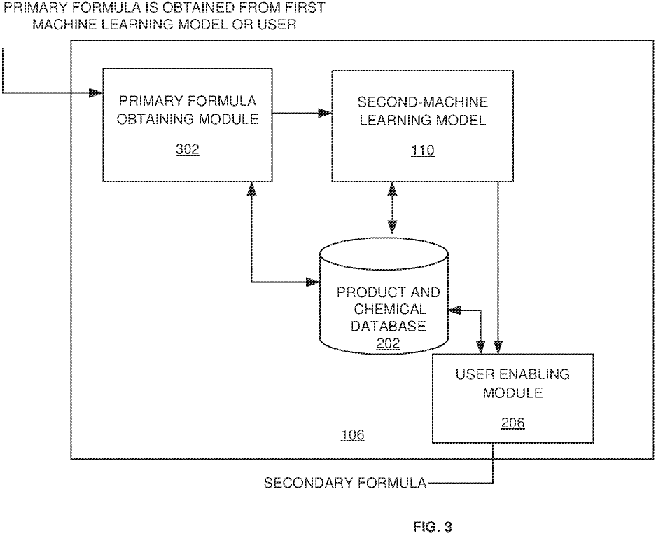

FIG. 3 is a block diagram that illustrates the formula suggesting server 106 that includes the second machine learning model 110 of FIG. 1, according to some embodiments herein. The formula suggesting server 106 includes the product database and chemical database 202, a primary formula obtaining module 302, the user enabling module 206, and the second machine learning model 110. The formula suggesting server 106 is configured to perform the ingredient search in the product database 202 using the second machine learning model 110 to suggest the list of related ingredients for the primary formula if the given ingredients in the primary formula are not relevant to the product specification or the performance rate of the primary formula that is inputted by the user is low.

The primary formula obtaining module 302 obtains the one or more ingredients with at least one desired function inputted by the user for the primary formula or the at least one first ingredient selected by the user from the set of ingredients suggested by the first machine learning model 108 for the primary formula through the user device 102. The second machine learning model 110 suggests the list of related ingredients that have a causal relationship with the primary formula and ranks the list of related ingredients based on the causal relationship with the primary formula. The second machine learning model 110 is trained based on causal relationships between features of historical ingredients or combinations of the historical ingredients for the product associated with the product category. The user enabling module 206 enables the user to select the at least one second ingredient from the list of related ingredients to obtain the secondary formula. The secondary formula includes either the at least one first ingredient or the one or more ingredients, along with the at least one second ingredient.

In some embodiments, if the user is satisfied with the secondary formula, then the third machine learning model 112 will not suggest any further adjustments to the concentrations of the ingredients. However, if the user wants to make further changes, the third machine learning model 112 can continue to provide suggestions for adjusting the concentrations until the user is satisfied.

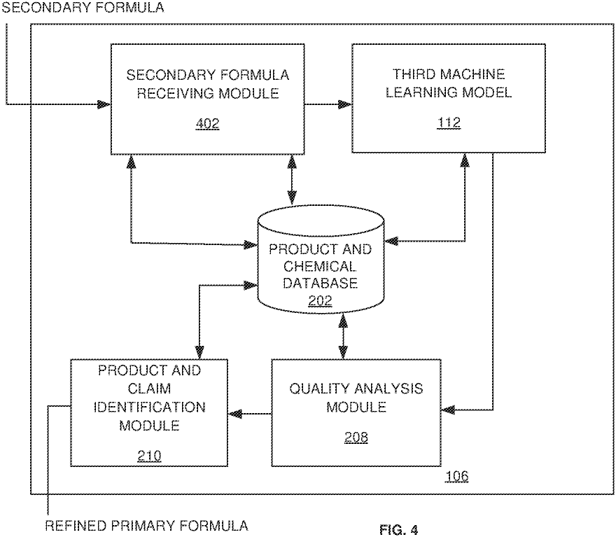

FIG. 4 is a block diagram that illustrates that formula suggesting server 106 that includes a third machine learning model 112 of FIG. 1, according to some embodiments herein. The formula suggesting server 110 includes the product and chemical database 202, the third machine model 112, the secondary formula receiving module 402, the quality analysis module 208, and the product and claim identification module 210. The secondary formula receiving module 402 receives the secondary formula automatically or inputted by the user. The third machine learning model 112 suggests a concentration for the secondary formula that performs the at least one desired function for the product category. The third machine learning model 112 is trained by correlating the historical ingredients with historical concentrations and historical desired functions.

The quality analysis module 208 validates the secondary formula by determining the performance rate of the secondary formula based on the at least one of the user preference, the safety score, the stability index, the claim association, and the innovation index of either the at least one first ingredient or the one or more ingredients, along with the at least one second ingredient by applying the fourth set of rules on the secondary formula. The quality analysis module 208 is configured to provide performance scores or rates and feedback to the user about the secondary formula. The score or rate is calculated based on the fourth set of rules and provided to the user in the format of scores 1 to 10 or the color code red (low), amber (moderate), and green (good). If the user is satisfied, then the secondary formula is fed into the Product and claim identification model 210. The product and the claim identification module 210 provide detailed information about the secondary formula for the user to map against the claim association or the at least one user preferences given. The product and the claim identification module 210 provides the information about the product in the form of performance rating that includes the claim association, stability index, the safety, market trends, and the innovation index. If the user is not satisfied with the secondary formula, the process of changing the formula and recommendation continues.

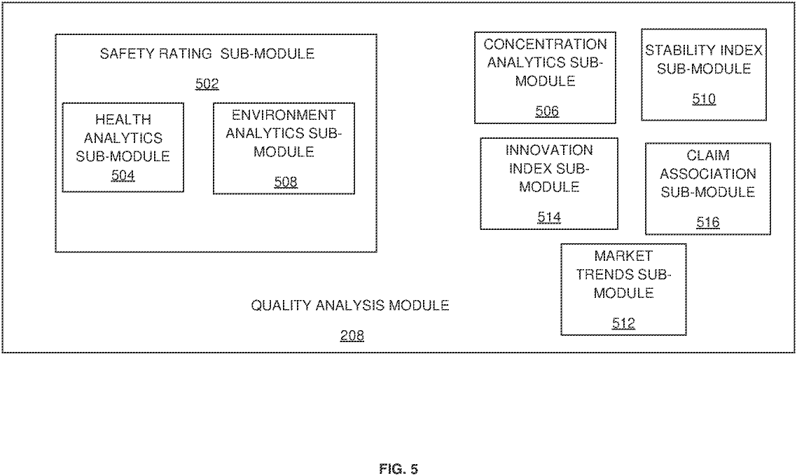

FIG. 5 is a block diagram of a quality analysis module 208 of the formula suggesting server 106, according to some embodiments herein. The quality analysis module 208 includes a safety rating analytics sub-module 502 a health analytics sub-module 504, a concentration analytics sub-module 506, an environmental analytics sub-module 508, a stability index sub module 510, a market trending submodule 512, an innovation index submodule 514, a claim association sub-module 516.

The safety rating analytics sub-module 502 is configured to provide safety rating for each ingredient based on factors like health and environment. The safety rating of each ingredient is determined by applying a fourth set of rules to the primary formula or the secondary formula based on various factors like a chemical composition of the ingredient and its source, how the chemical composition is produced, and processed, and how the chemical composition is used in different products. By considering all these factors, the safety rating analytics sub-module 502 provides the safety rating that helps the user make informed decisions about use of ingredients in its products. In some embodiments, the safety rating analytics sub-module 502 provides the safety rating for each ingredient on a numerical scale with respect to severity, safety, potential impact, compliance, and the data evidence/availability. For example, if the safety rating is between 8 to 10, it indicates that a probability of the primary formula or the secondary formula is high, and a severity and impact on health and environment are low. Similarly, if the ingredient rating is between 4 to 7, it indicates that a probability for the primary formula or the secondary formula is moderate, and the severity and impact on health and environment for the primary formula or the secondary formula are moderate. Similarly, if the ingredient rating is between 1 to 3, it indicates that the probability for the primary formula or the secondary formula is low and the severity and impact on health and environment for the primary formula or the secondary formula are high.

In some embodiments, the safety rating analytics sub-module 502 provides the safety rating for the primary formula or the secondary formula based on color codes which is a simple and easy qualitative representation based on no-data, no-health issue, acute and chronic health/environmental data evidence. The color codes may be green, amber, or red codes. For example, the safety rating analytics sub-module 502 provides the green code for the ingredient, it indicates that the probability for the primary formula or the secondary formula is high and the severity and impact on health and the environment for the primary formula or the secondary formula is low. If the safety rating analytics sub-module 502 provides the amber code for the ingredient, it indicates that the probability for the primary formula or the secondary formula is moderate and the severity and impact on health and environment for the primary formula or the secondary formula is moderate. If the safety rating analytics sub-module 502 provides the red code for the ingredient, it indicates that the probability for the primary formula or the secondary formula is low and the severity and impact on health and environment are high. The concentration analytics sub-module 506 is configured to determine whether the given concentration ranges for the selected or given ingredients are above the compliance threshold or market threshold range and perform ingredient ratings using the fourth set of rules. In some embodiments, the concentration analytics sub-module 506 is further configured to analyze the suggested concentration for the secondary formula or the primary formula by determining whether the suggested concentration ranges for the secondary formula or the primary formula are within a threshold or above the threshold. The concentration ranges are compared with the historical ingredients of the historical product category in two methods. The three methods may include (i) whether the ingredient concentration or position is with respect to the product category for the at least one desired function, (ii) whether the ingredient concentration or position is with respect to the claim category or at least one desired function the ingredients fall under the compliance check, then the concentration verification will be verified based on a country-specific threshold and (iii) if the ingredients do not fall under the compliance check, the concentration will be verified based on market optimum range. If the concentration ranges are within the threshold, then the formula suggesting server 106 is configured to perform real-time ingredient rating. If the concentration ranges are above the country-specific threshold/market optimum range, then the third machine learning model 112 enabled by the user to refine the suggested concentration for the secondary formula to optimum concentration ranges and provide the threshold limit and warnings to the user.

The environment analytics sub-module 508 rates the environmental impact of the primary formula or the secondary formula by considering various factors such as the biodegradability of ingredients, potential ecological risks, and sustainability considerations using the third set of rules. The innovation index sub- module 514 indexes the primary formula or the secondary formula using the second set of rules and the third set of rules to assess a level of the primary formula or the secondary by evaluating the uniqueness of the formulated product in relation to existing products or industry standards formula by using predefined criteria and guidelines. The claim association submodule 516 checks whether the primary formula or the secondary formula meets specific benefits of the product prescribed by the user. The market trends sub-module 518 rates the primary formula or the secondary formula based on market trends of ingredient based on their function and usability frequency in a product category

The fourth set of rules may include (i) should comply with regulatory standards and restrictions set by relevant authorities. should not contain ingredients known to cause allergies or sensitivities, (ii) should not exceed safety limits or known thresholds for potential adverse effects, (iii) should not exceed safety limits or known thresholds for potential adverse effects, and (iv) should meet specific functional requirements, such as pH range, viscosity, stability, or desired performance attribute.

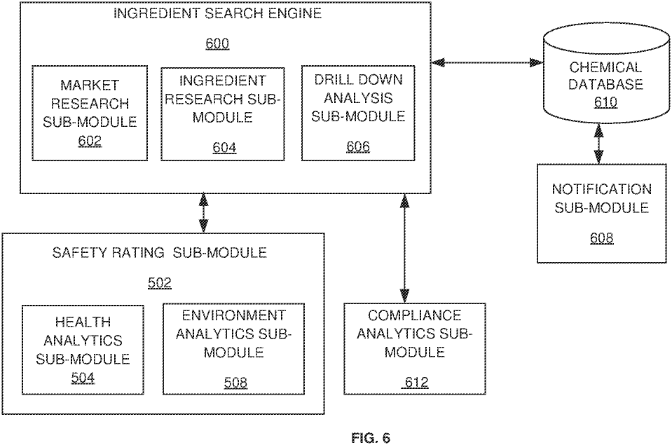

FIG. 6 is a block diagram of an ingredient search engine 600 of the formula suggesting server 106 according to some embodiments herein. The ingredient search engine 600 includes a market research submodule 602, an ingredient research submodule 604, a drill down analysis submodule 606, a notification submodule 608, and a chemical database 610. The chemical database includes 610 different chemical compounds, such as molecular structure, properties, reactions, uses and threshold level, and compliance check of the chemical or one or more ingredients.

The safety rating analytics sub-module 502 is configured to provide safety rating for each ingredient based on factors like health and environment. The safety rating of each ingredient is determined by applying the fourth set of rules to each ingredient in the set of ingredients and the list of related ingredients based on various factors like a chemical composition of the ingredient and its source, how the chemical composition is produced, and processed, and how the chemical composition is used in different products. By considering all these factors, the safety rating analytics sub-module 502 provides the safety rating that helps the user make informed decisions about use of ingredients in its products. In some embodiments, the safety rating analytics sub-module 502 provides the safety rating for each ingredient on a numerical scale with respect to severity, safety, potential impact, compliance, and the data evidence/availability. For example, if the ingredient rating is between 8 to 10, it indicates that a probability of suitability of the ingredient for the primary formula or the secondary formula is high, and a severity and impact on health and environment are low. If the ingredient rating is 10, then the ingredient is a verified ingredient that is highly suitable for the primary formula or the secondary formula. Similarly, if the ingredient rating is between 4 to 7, it indicates that a probability of suitability of the ingredient for the primary formula or the secondary formula is moderate, and the severity and impact on health and environment for the primary formula or the secondary formula are moderate. Similarly, if the ingredient rating is between 1 to 3, it indicates that the probability of suitability of the ingredient for the primary formula or the secondary formula is low and the severity and impact on health and environment for the primary formula or the secondary formula are high. If the ingredient rating is 0, then the ingredient is a banned ingredient and is not recommended for product development.

In some embodiments, the safety rating analytics sub-module 502 provides the safety rating for each ingredient based on color codes which is a simple and easy qualitative representation based on no-data, no-health issue, acute and chronic health/environmental data evidence. The color codes may be green, amber, or red codes. For example, the safety rating analytics sub-module 502 provides the green code for the ingredient, it indicates that the probability of suitability of the ingredient for the primary formula or the secondary formula is high and the severity and impact on health and the environment for the primary formula or the secondary formula is low. If the safety rating analytics sub-module 502 provides the amber code for the ingredient, it indicates that the probability of suitability of the ingredient for the primary formula or the secondary formula is moderate and the severity and impact on health and environment for the primary formula or the secondary formula is moderate. If the safety rating analytics sub-module 502 provides the red code for the ingredient, it indicates that the probability of suitability of the ingredient for the primary formula or the secondary formula is low and the severity and impact on health and environment are high. The rating scale for the ingredient is directly proportional to the specific ingredient’s safety data. The health analytics sub-module 504 is configured to collect the health hazard data related to the set of ingredients or the list of related ingredients. The health analytics information of the health hazard data is sourced from a governmental database and is related to the concentration of chemicals in the set of ingredients or the list of related ingredients with any limitations or restrictions based on country regulations. The health analytics information is stored in the chemical database along with other related information about the handling of chemicals that enables it to provide accurate safety ratings for the set of ingredients or the list of related ingredients.

The compliance analytics sub-module 612 is configured to determine whether the given concentration ranges for the selected or given ingredients are above the compliance threshold or market threshold range and perform ingredient ratings using the fourth set of rules. The ingredient concentration ranges are compared with the historical ingredients of the historical product category in two methods that include \(i) whether the ingredient concentration or position is with respect to the claim category or at least one desired function the ingredients fall under the compliance check, then the concentration verification will be verified based on a country-specific threshold and (ii) if the ingredients do not fall under the compliance check, the concentration will be verified based on market optimum range. If the concentration ranges are within the threshold, then the formula suggesting server 106 is configured to perform real-time ingredient rating. The environment analytics sub-module 508 is configured to collect the environment hazard data related to the set of ingredients or the list of related ingredients by mapping against the product and chemical database 202 to identify any environment hazards associated with the selected or given ingredients. This helps to ensure that products are not only safe for human use but also safe for the environment. The stability index submodule 510 is configured to determine the stability index by automatically calculating an index position of each ingredient in the secondary formula or the primary formula based on the one or more inputs given by the user.

If the user wants to create a primary formula, the user enables the market research sub-module 602 is configured to identify trending ingredients and the optimum concentration range used for every product category. This assists the user to research ingredients that are the most commonly or widely used ingredient for a specific product category. The user can use trending ingredient information to research and select trending ingredients for their own product for the market. The ingredient research sub-module 604 is configured to search and provide the set of trending ingredients that are suitable for the ideation and product specification based on one or more criteria that include, not limited to, the function or a nature of the ingredients, a regulatory compliance, a safety information of the ingredients, market trends, ingredient trends with respect to the product type and the product category, and the use category. The ingredient research sub-module 604 can be helpful for users who are looking to create a new product or reformulate an existing one, this saves time and effort of the user in the formulation process. The drill-down analysis sub-module 606 is configured to search the information ingredients more efficiently based on their requirements, which reduces time and effort to identify the right suitable ingredient for the product specification. The users can input specific criteria or attributes that they are looking for in the drill-down analysis sub-module 606 which may narrow down the search results to show only the relevant ingredients or trending ingredients that meet user preferences and criteria. The drill-down analysis sub-module 606 can be helpful for users who need to find specific ingredients for their product formulations or who want to explore different options based on their requirements.

In some embodiments, the ingredient research sub-module 600 is configured to perform the ingredient search by (i) searching, using a search intelligence or a search engine, one or more trending ingredients in the chemical database 610, by inputting the primary formula or the ideation and product specification or the one or more inputs or the user preference, (ii) providing a list of trending ingredients which are suitable for the primary formula based on the one or more inputs or the user preference based on one or more criteria that include, not limited to, the function or a nature of an ingredient, regulatory compliance, safety information of the ingredients, market trends, ingredient trends with respect to the product type and the product category, and the use category, and (iii) enabling the user to select at least one trending ingredient from the list trending ingredients for the product category. The ingredient research sub-module 600 is further configured to search one or more multifunctional ingredients or combined functionality for an ingredient for the given primary formula or the ideation and the product specification or the one or more inputs or the user preference, thereby reducing the number of ingredients for developing the product and cost incurred for an additional ingredient.

The ingredient search engine 600 assists users in developing innovative and effective product formulations. The ingredient search engine 600 is configured to generate, using the fourth set of rules, the ingredient rating for each ingredient in the primary formula, or the ideation based on the one or more criteria that include, but are not limited to, the function of each ingredient, the health hazard data, the environment hazard data, compliance, purity information of each ingredient, active concentration of each ingredient, impurities levels of each ingredient, or the nature of each ingredient. The ingredient search engine 600 is further configured to generate, using the fourth set of rules, the product rating based on the following information, but not limited to, the ingredient rating of each ingredient, the health hazard data, the quality of the formulation, and compliance, thereby, the ingredient search engine 600 also provides a rating for a product based on the inputs given by the user in real-time. The notification 608 submodule alerts the user when the formula suggesting server 106 receives a new ingredient that has arrived in the market.

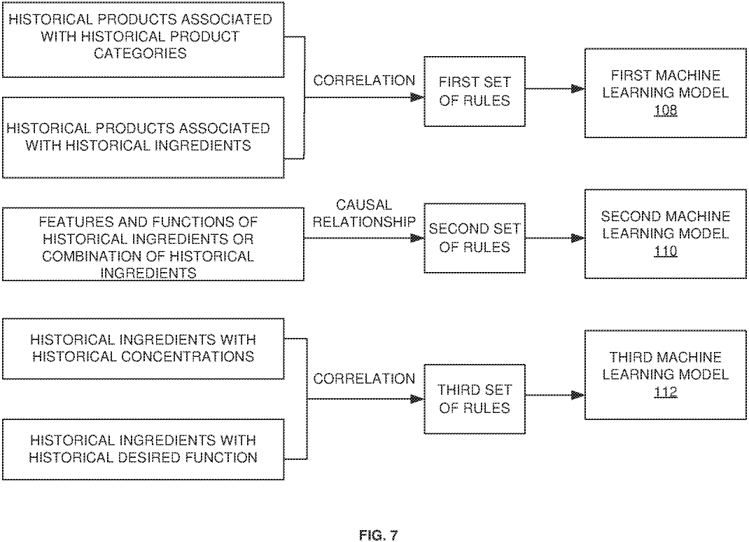

FIG. 7 is a block flow diagram that illustrates a process illustrates a method of training machine learning models according to some embodiments herein. The machine learning models include a first machine learning model 108, a second machine learning model 110, and a third machine learning model 112. The first machine learning model 108 is trained using a first set of rules that correlates historical products that have been associated with product categories and the historical ingredients. The first set of rules may include validating the desired function and ingredients present for the respective product category.

The second machine learning model 110 is trained using a second set of rules that identify causal relationships between features of historical ingredients or combinations of historical ingredients for products associated with the product category. The second set of rules may include combinations of the ingredients that have synergistic effects in the product category. The second set of rules may include cause-and-effect relationships between ingredient features and specific functional properties or performance attributes desired in the product category. The second set of rules may include an impact of ingredient features on sensory attributes like texture, color, or appearance, based on the features of historical ingredients or combinations of historical ingredients. The second set of rules may include the causal relationships between features of the ingredient and regulatory guidelines or safety considerations within the product category.

The third machine learning model 112 is trained using a third set of rules that correlate historical ingredients with historical concentrations and desired functions. The third set of rules may include the correlation of specific ingredient concentrations with desired functions. For example, higher concentrations of ingredient A tend to be more effective for meeting Function X, while lower concentrations are sufficient for Function Y. The third set of rules may include guidelines for ingredient concentrations. For example, suggest the concentration of ingredient B below a certain threshold to avoid adverse reactions with ingredient C. The third set of rules may include the relationship between ingredient concentrations and their effectiveness in meeting at least one desired function and the concentration ranges that have historically produced best results for the at least one desired function.

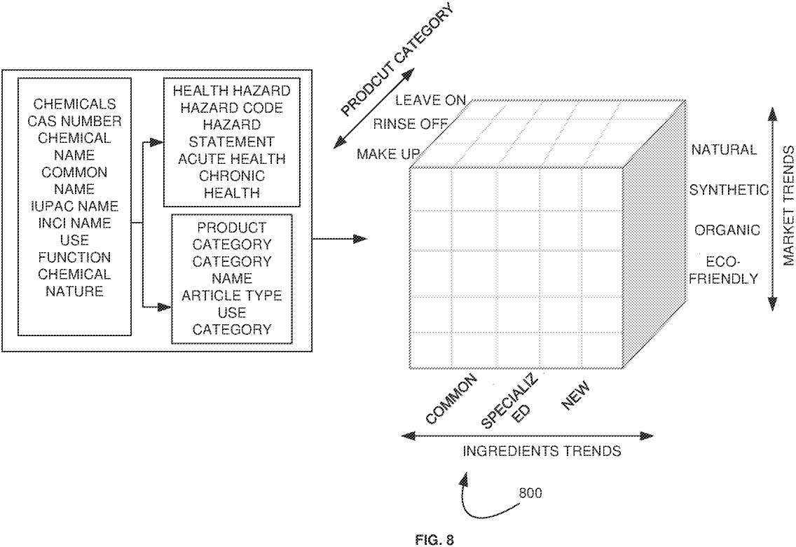

FIG. 8 illustrates an exemplary multidimensional report 800 of ingredients trends vs market trends vs product categories that are generated based on chemical data, health hazard data, and product category data, according to some embodiments herein. In the multidimensional report 800, the ingredients trends are plotted on an X-axis, the market trends are plotted on a Y-axis, and the product category is plotted on a Z-axis. This allows users to visualize and analyze the data from different perspectives, making it easier to identify the appropriate ingredient that may be utilized for the primary formula or the secondary formula, or the new formula. The multidimensional report 800 is generated based on the chemical data of the ingredient, the health hazard data, and the product category data of the ingredients which are searched by the user. The chemical data of the ingredient includes CAS number, chemical name, common name, IUPAC name, INCI name, a use function, a chemical nature, a hazard code, and compliance. These attributes provide detailed information about the ingredients, which may be used to filter and select specific chemicals based on various criteria. The health hazard data includes a hazard code, a hazard statement for acute and chronic health data. The product category includes a category name, an article type, and a use category. The attributes for evaluating the potential risks associated with the use of the ingredients and ensuring compliance with health and safety regulations. The multidimensional search enables users to select chemicals based on various criteria such as the product type, the use function, the health hazard, the market trends, ingredients trends, etc. These attributes provide information about the different types of cosmetic ingredients and their intended uses. For example, a cosmetics company wants to develop a new line of skincare products that are natural and free from potentially harmful chemicals. The cosmetics company may use the multidimensional report 800 to identify ingredients that meet its criteria.

First, the company may filter the multidimensional report 800 based on the product category attribute to only show ingredients that are suitable for skincare products, e.g., natural Rose oil and Vitamin C for anti-wrinkle face cream. Then, they may filter by the chemical data attributes to only include ingredients that are natural and comply with relevant regulations. Next, they may use the health hazard data attributes to identify ingredients that are not associated with any chronic health risks. Finally, the cosmetics company can use the multidimensional report’s graphical representation to identify trends in ingredients, market, and product categories that align with their brand values and customer/user preference via ingredient suggestions (eg. the most widely used natural trending ingredient in the market currently) in their primary formula or in the formula. Based on the results of the analysis, the cosmetics company may select ingredients from the set of trending ingredients or the list of related ingredients or the one or more trending ingredients to use in their new skincare line that meets their criteria for natural, safe, and on-trend products.

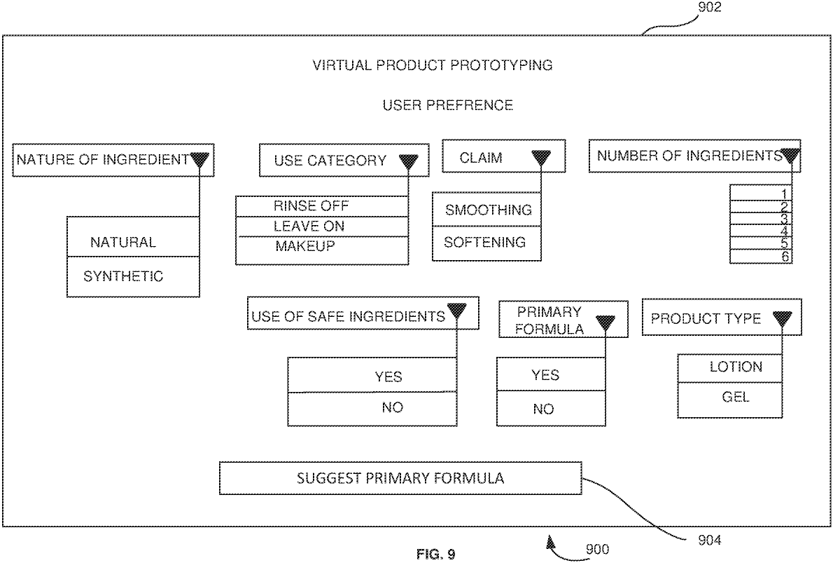

FIG. 9 illustrates an exemplary user interface 900 view of a selection of preferences by the user for generating the primary formula according to some embodiments herein. The user interface 900 displays product specifications at field 902. The user may select the preferences from the product category that includes hair, face, oral, and body. The user may select the preferences from the use category that includes rinse-off, leave-on, leave-on, and makeup. The user may select the preferences of ingredient count from the number of ingredients that includes 1 to 6 or more for the product. The user may select the preferences from the nature of the ingredient category which includes a natural, synthetic, or combined category. The user may indicate their preference for the use of safe ingredients by selecting either the “yes” or “no” option. The user can choose their preference between a claim of the product by selecting either smoothing or softening options. The user may select the preferences from the product type which includes Aloe vera lotion. The user may input their primary formula by choosing an option between the “yes” or “no”. If the user selects “No” in the input, the first machine learning model 108 suggests the set of ingredients with respect to the primary functions of the product category for the primary formula based on the preferences selected by the user. If the user selects “yes” in the input, the quality analysis module 208 validates the primary formula. The user may have the option to the “suggest primary formula” 904 once the user has selected their preferences.

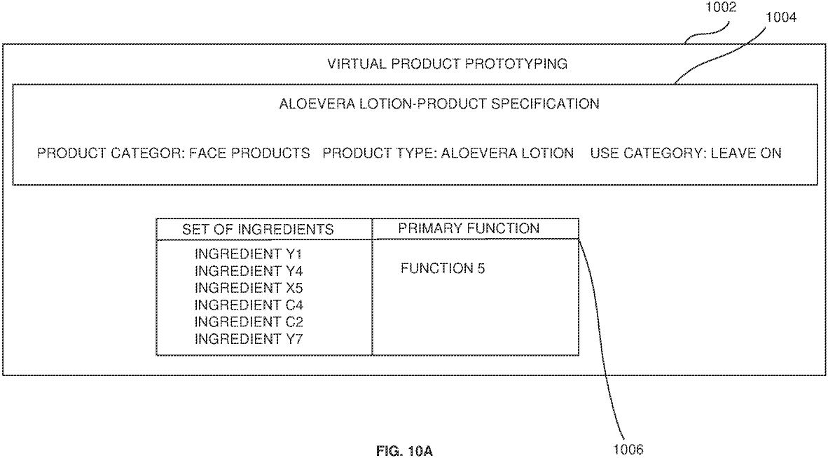

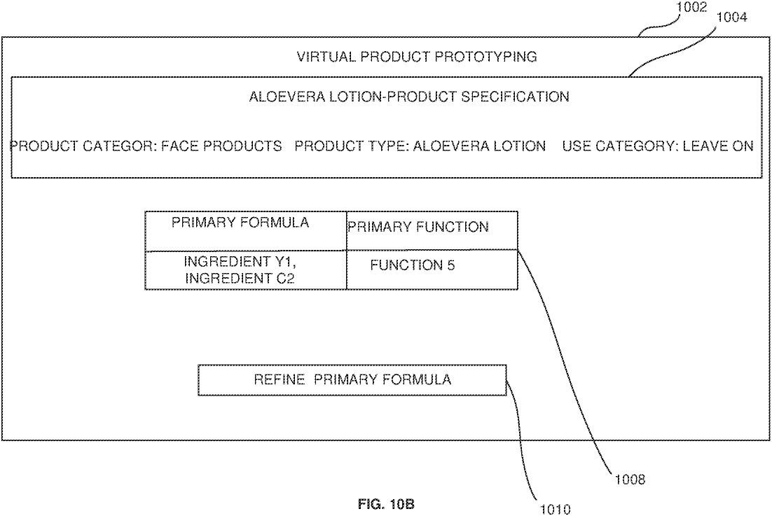

FIG. 10A illustrates an exemplary user interface 1002 view of virtual prototyping of the formula suggesting server 110 that suggests a set of ingredients for a primary formula based on the user preferences and a primary function of a product category, according to some embodiments herein. The user interface 1002 displays product specifications in field 1004. For example, the product specification that is selected by the user from the user preferences such as leave-on as a use category, aloe vera lotion as a product type, and face products as a product category. The user interface 1002 displays primary functions that are relevant to the product category and the set of suggested ingredients that are relevant to the primary function and the product category at field 1006. The user interface 1002 displays the set of ingredients such as “ingredient Y1, ingredient Y4, ingredient X5, ingredient C4, ingredient C2, and ingredient Y7 with the primary function “function 5” at field 1006. For example, the user interface 1002 displays the primary functions that are relevant to face lotions as the product type, such as moisturizing and soothing. For example, if the user selects “face wash” as the product category and “cleansing” is the primary function, the first machine learning model 108 might suggest the set of ingredients like salicylic acid or glycolic acid, and these suggested ingredients are relevant to the primary function and product category and this can help the user to create the primary formula for the product that meets the user preferences.

FIG. 10B illustrates the exemplary user interface 1002 view of virtual prototyping of the formula suggesting server 106 that shows at least one first ingredient for the primary formula, according to some embodiments herein. The user interface 1002 displays a primary formula at a field of 1008. The primary formula includes ingredient Y1 and ingredient C2 selected by the user from the set of trending ingredients. The user can also search for another set of ingredients to improvise the primary formula. So, the user interface 1002 also displays a “refine primary formula” option 1010 to allow users to improve the primary formula.

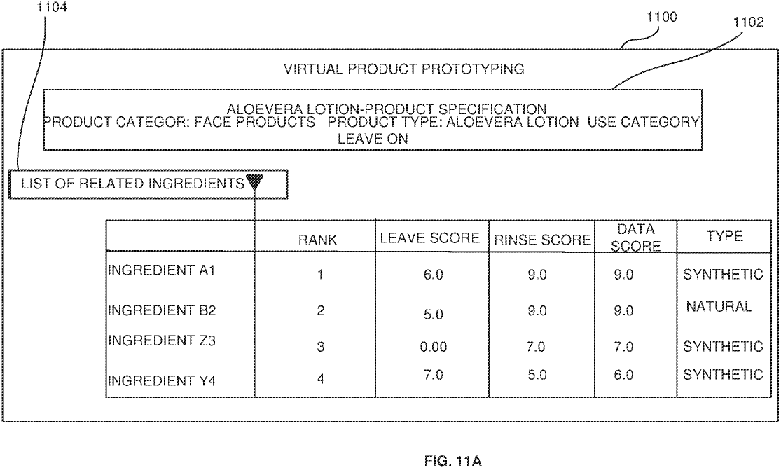

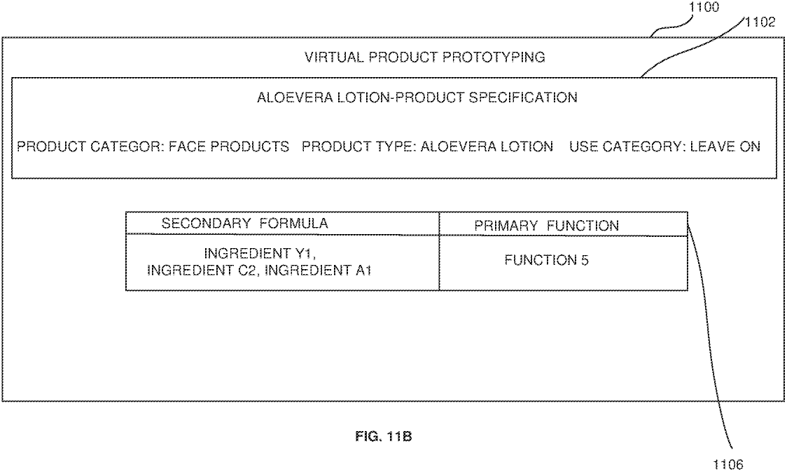

FIG. 11A illustrates an exemplary user interface 1100 view of a virtual product prototyping of the formula suggesting server 106 that suggests the list of related ingredients according to some embodiments herein. The user interface 1100 displays product specifications at a field 1102. For example, the product specification includes Leave On as a use category, Aloe vera lotion as a product type, and face products as a product category that are selected by the user from the user preferences. If the primary formula is not suitable for the selected product category or the user is not satisfied with the primary formula, the list of related ingredients is suggested at 1104 for the primary formula by the second machine learning model 110. The user interface 1100 displays the list of related ingredients 1104 with information about rank, leave on score, rinse-off score, makeup score, and type of the list of related ingredients.

FIG. 11B illustrates an exemplary user interface view 1100 of virtual prototyping of the formula suggesting server that shows the at least one first ingredient and at least one second ingredient for the secondary formula according to some embodiments herein. The user interface 1100 displays a secondary formula at a field of 1102. The secondary formula includes ingredient Y1, ingredient C2, and ingredient A1. The ingredient A1 is selected by the user from the list of related ingredients 1104. In an example embodiment, as per the user criteria/ preferences (including product category, claim association, number of ingredients etc.), numerous clusters are created, and each cluster works based on the user preferences. Based on the specifications/criteria/preferences entered by the user as the one or more inputs, the first machine learning model 108 suggests the set of ingredients. If the user selects ‘Disodium succinate’ as a first ingredient and then the second machine learning model 110 suggests a next ingredient based on the causal relationship with respect to the desired function. The set of suggested ingredients may include dipropylene glycol, succinic acid, tea-lauryl sulfate, titanium dioxide, theobroma cacao butter, stearyl alcohol, stearic acid, squalene, styrax tonkinensis resin extract, sorbitol, sucrose laurate, sucrose, sweet almond witch hazel and water Position. After an initial recommendation, based on the user selection or user input or the user preference, the second machine learning model 110 receives a new input and starts recommending the user based on the desired function and this continues until the formula is completed. With the previous example, if the user selects dipropylene glycol as second ingredient, based on this selection the user receives another new set of recommendations for a third position. The ingredients for a third position include succinic acid, sodium citrate, diglycerin, peg-20 glyceryl diisostearate, peg-8, tea tree leaf oil, titanium dioxide, sorbitol, theobroma cacao (cocoa) seed butter, soybean oil, stearoxytrimethylsilane, stearyl alcohol, stearic acid, and squalane.

The second machine learning model 110 suggests the list of related ingredients for the primary formula according to the user’s preferences through the following methods, a) suggesting ingredients based on the user’s selected ingredients, for example, the user wants to create a facial serum and has selected ingredients such as hyaluronic acid, vitamin C, and niacinamide. The second machine learning 110 might suggest additional ingredients such as aloe vera, glycerin, and green tea extract to create a hydrating and nourishing serum. b) suggesting ingredients based on the desired function, for example, the second machine learning model 110 might suggest ingredients that brighten the skin or reduce the appearance of fine lines and wrinkles. and c) suggesting individual ingredients when the user inputs only one ingredient, for example, if the user inputs only one ingredient (e.g., “vitamin C”), the second machine learning model 110 might suggest other ingredients that are commonly used in facial serums that contain vitamin C, such as ferulic acid, retinol, or alpha arbutin.

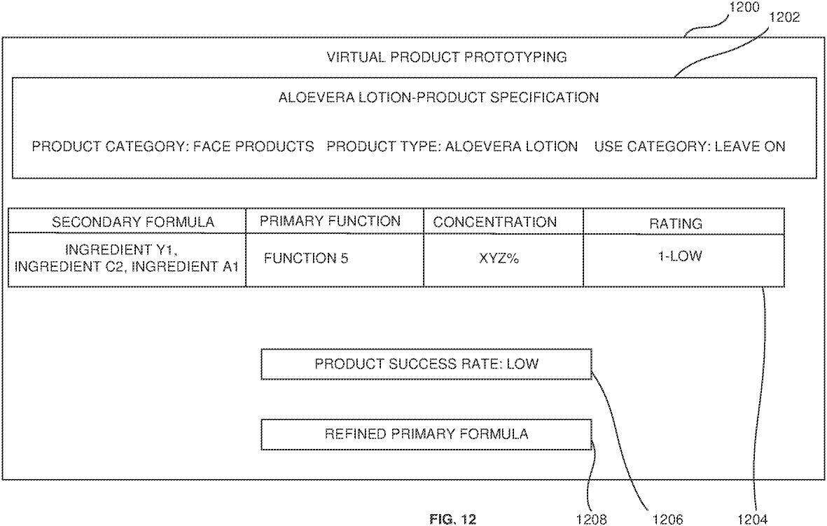

FIG. 12 is an exemplary user interface 1200 view of a dashboard of a virtual product prototyping of the formula suggesting server 106 that suggests a concentration for the secondary formula based on the desired function of the product category according to some embodiments herein. The user interface 1200 displays product specifications in field 1202. For example, the product specification includes Leave On as a use category, Aloe vera lotion as a product type, and face products as a product category that are selected by the user from the user preferences. The user interface 1202 displays the concentration for the secondary formula at a field of 1204. For example, “XYZ%” concentration is suggested for the secondary formula by the third machine learning model 112 to perform the desired function of the product category. The user can also search for another list of related ingredients to improvise the secondary formula. The user interface 1200 displays “refine the primary formula” option 1208. So, the user can choose the option 1208 if the user is not satisfied with the secondary formula or if the performance rate of the secondary formula is low which is displayed in field 1206.

For example, the user wants to create a new aloe vera lotion with the desired function of moisturizing and soothing dry skin. The first machine learning model 108 suggests the set of ingredients for the primary formula, including aloe vera gel, water, and glycerin. The user selects aloe vera gel as a first ingredient from the set of ingredients. Then, the second machine learning model 110 suggests a list of related ingredients that have a causal relationship with the primary formula, based on historical ingredients and their combinations. The second machine learning model 110 suggests the list of related ingredients like shea butter, jojoba oil, and vitamin E, which have been shown to work well with aloe vera gel for moisturizing and soothing dry skin. The user selects shea butter from the list of related ingredients to create the secondary formula. The third machine learning model 112 suggests the concentration for the aloe vera gel and shea butter in the secondary formula that will meet the desired function of moisturizing and soothing dry skin for the product category of the aloe vera lotion and ranks the suggested concentration for the aloe vera gel and shea butter in the secondary formula to perform the desired function of the aloe vera lotion.

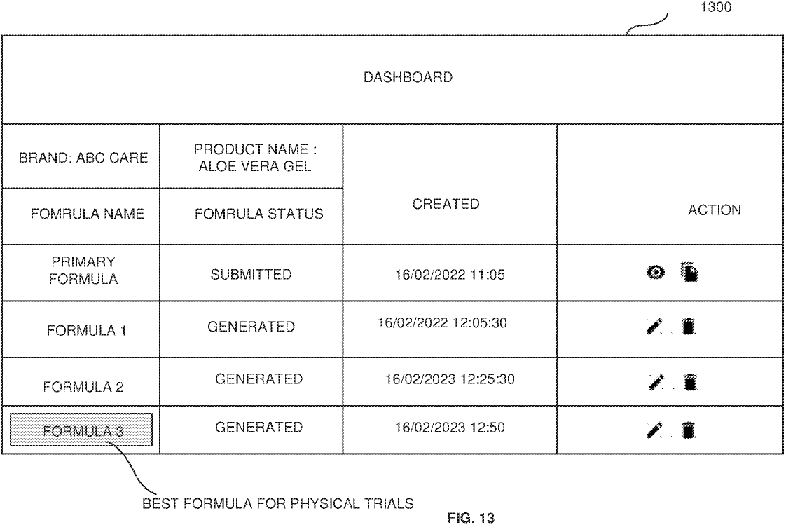

FIG. 13 illustrates an exemplary user interface view of dashboard 1300 of the formula suggesting server 106 of FIG. 1 that prompts a best formula for physical trials using machine learning models, according to some embodiments herein. The dashboard 1300 shows a product name, a name of a formula, a formula status, a date and time of creation of the formula, and one or more action buttons to edit, clone, or delete the formula. For example, the product name is Aloe vera lotion. The name of a formula such as primary formula, formula 1, formula 2, and formula 3. The formula status may be “submitted” or “generated.” The user interface 1300 prompts the best formula to the user for performing a physical trial in a lab. For example, the user interface 1300 prompts the formula 3 (which is highlighted in gray color) to the user for performing physical trials in the lab, which means the formula is frozen. Once the formula is frozen, it is typically considered to be in its final state and may be moved forward to the next stage of product development. The freezing of the formula in the product development process allows developers to evaluate the performance of the formula and make necessary adjustments before production begins. This can help ensure that a final product meets product specifications and quality standards for the product category.

The best formula is a formula that is predicted, using at least one machine learning model, to have a high probability performance rate. With obtained one or more inputs of the user regarding a product to be developed, the formula suggesting server 106 identifies an optimum qualitative and quantitative formula that is applied against the primary formula and predicts whether the identified formula has the high probability performance rate. Further, the formula suggesting server 106 identifies alternate ingredients and concentrations that will be suitable for each product type or product category, thereby enabling the user to create new formulas such as formula 1, formula 2, and formula 3 which in turn leads the user to create the high probability performance rate formula.

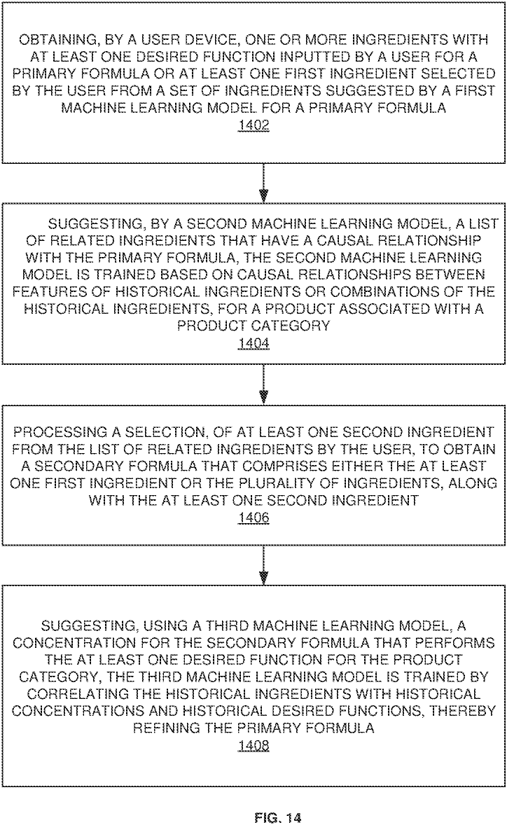

FIG. 14 is a flowchart that illustrates a method for automatically suggesting a formula for a product based on a user preference and a desired function using machine learning models, according to some embodiments herein. At step 1402, the method includes obtaining, by a user device, one or more ingredients with at least one desired function inputted by a user for a primary formula or at least one first ingredient selected by the user from a set of ingredients suggested by a first machine learning model for a primary formula. At a step 1404, the method includes suggesting, by a second machine learning model, a list of related ingredients that have a causal relationship with the primary formula. At a step 1406, the method includes processing a selection of at least one second ingredient from the list of related ingredients by the user, to obtain a secondary formula that includes either the at least one first ingredient or the plurality of ingredients, along with the at least one second ingredient. At a step 1408, the method includes suggesting, using a third machine learning model, a concentration for the secondary formula that performs the at least one desired function for the product category, thereby refining the primary formula.

The method assists a user to identify probable performing and non-performing formulas without a physical trial using machine learning models. The method reduces a time, cost, and effort in physical trials for the users. The method minimizes the trial by avoiding non-performing formulas as part of the physical trials and makes the product launches faster and more efficiently. The method considers the user’s preferences when generating and refining formulas, which can lead to more personalized and satisfying products. The method also considers the safety score, and stability of ingredients when suggesting formulas, which can help ensure that the final product is both safe and stable. The method may be applied to a wide range of product categories such as textiles, cosmetics, beverages, etc. for product development. The machine learning models recommend minimum of 30 formulae in less than 2 seconds, and the machine learning models can recommend minimum of 40 ingredients in less than 1 seconds. Hence, the computational power of the product development system is less.

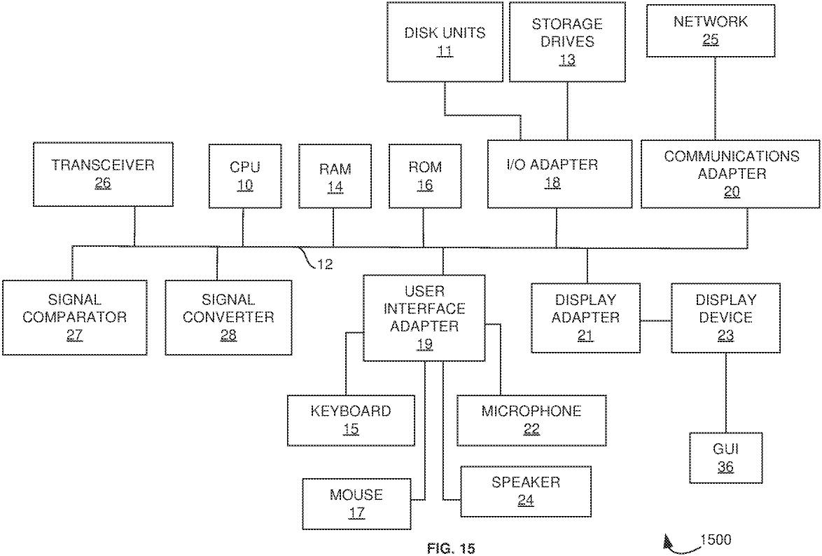

A representative hardware environment for practicing the embodiments herein is depicted in FIG. 15 with reference to FIGS. 1 through 14. This schematic drawing 1500 illustrates a hardware configuration of a system 100 or a user device or a formula suggesting server 106 or a computing device, in accordance with the embodiments herein. The system 100 includes at least one processing device 10 and a cryptographic processor 11. The system 100 may include one or more of a personal computer, a laptop, a tablet device, a smartphone, a mobile communication device, a personal digital assistant, or any other such computing device, in one example embodiment. The system 100 includes one or more processor (e.g., the processor 108) or central processing unit (CPU) 10. The CPUs 10 are interconnected via system bus 12 to various devices such as a random-access memory (RAM) 14, read-only memory (ROM) 16, and an input/output (I/O) adapter 18. Although CPUs 10 are depicted, it is to be understood that the system 100 may be implemented with only one CPU.

The I/O adapter 18 can connect to peripheral devices, such as disk units 11 and storage drives 13 (tape drives), or other program storage devices that are readable by the 100. The system 100 can read the inventive instructions on the program storage devices and follow these instructions to execute the methodology of the embodiments herein. The system 100 further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network, and a display adapter 21 connects the bus 12 to a display device 23, which provides a graphical entity interface (GUI) 36 of the output data in accordance with the embodiments herein, or which may be embodied as an output device such as a monitor, printer, or transmitter, for example. Further, a transceiver 26, a signal comparator 27, and a signal converter 28 may be connected with the bus 12 for processing, transmission, receipt, comparison, and conversion of electric signals.

The embodiments herein can take the form of, an entire hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk -read only memory (CD-ROM), compact disk - read/write (CD-R/W) and DVD.

A data processing system suitable for storing or executing program code will include at least one processor coupled directly or indirectly to memory elements through a system bus. The memory elements can include local memory employed during actual execution of the program code, bulk storage, Subscriber Identity Module (SIM) card, and cache memories which provide temporary storage of at least some program code in order to reduce the number of times code must be retrieved from bulk storage during execution. Input/output (I/O) devices (including but not limited to keyboards, displays, pointing devices, remote controls, camera, microphone, temperature sensor, accelerometer, gyroscope, etc.) can be coupled to the system 100 either directly or through intervening I/O controllers. Network adapters may also be coupled to the system 100 to enable the data processing system to become coupled to other data processing systems or remote printers or storage devices through intervening private or public networks. Modems, cable modem and Ethernet cards are just a few of the currently available types of network adapters.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of employed herein is for the purpose of description and not of limitation. Therefore, while the embodiments herein have been described in terms of preferred embodiments, those skilled in the art will recognize that the embodiments herein can be practiced with modification within the scope of the appended claims.

What is claimed is:

1. A processor-implemented method for automatically suggesting a formula for a product based on a user preference and a desired function using machine learning models, comprising:
obtaining a plurality of ingredients with at least one desired function inputted by a user associated with a user device for a primary formula or at least one first ingredient selected by the user from a set of ingredients suggested by a first machine learning model for a primary formula;
suggesting, by a second machine learning model, a list of related ingredients that have a causal relationship with the primary formula, wherein the second machine learning model is trained based on causal relationships between features of historical ingredients or combinations of the historical ingredients using a second set of rules, for a product associated with a product category;
processing a selection, of at least one second ingredient from the list of related ingredients by the user, to obtain a secondary formula that comprises either the at least one first ingredient or the plurality of ingredients, along with the at least one second ingredient; and
suggesting, using a third machine learning model, a concentration for the secondary formula that performs the at least one desired function for the product category, wherein the third machine learning model is trained by correlating the historical ingredients with historical concentrations and historical desired functions based on a third set of rules, thereby refining the primary formula.

2. The processor-implemented method of claim 1, wherein the set of ingredients is suggested by
(i) receiving, using a user device, an input from the user, wherein the input of the user comprises a product category, at least one user preference, and the at least one desired function;
(ii) determining, using the first machine-learning model, at least one primary function for the product category and suggesting the set of ingredients for the product category based on the at least one user preference and the at least one primary function, wherein the first machine learning model is trained by correlating historical products associated with historical product categories with the historical ingredients associated with the historical products based on a first set of rules; and
(iii) processing the selection of the at least one first ingredient from a set of suggested ingredients, to obtain the primary formula that comprises the at least one first ingredient.

3. The processor-implemented method of claim 2, wherein the method comprises validating the primary formula by determining a performance rate of the primary formula based on the at least one user preference, a safety score, a stability index, a claim association, or an innovation index of the at least one first ingredient or the plurality of ingredients of the primary formula by applying a fourth set of rules on the primary formula.

4. The processor-implemented method of claim 1, wherein the method further comprises ranking the list of related ingredients that are matched with the primary formula based on the causal relationship with the primary formula.

5. The processor-implemented method of claim 1, wherein the method further comprises ranking the concentration of each ingredient in the secondary formula to perform the at least one desired function of the product category.

6. The processor-implemented method of claim 3, wherein the method comprises refining, by the second machine learning model, the primary formula by suggesting the list of related ingredients if the performance rate of the primary formula is below a threshold level.

7. The processor-implemented method of claim 6, wherein the method comprises refining, by the second machine learning model, the primary formula by suggesting the list of related ingredients if the at least one first ingredient of the primary formula is not relevant to the at least one user preference or if the user does not satisfy with the at least one first ingredient of the primary formula that is validated.

8. The processor-implemented method of claim 1, wherein the method comprises validating, by applying the fourth set of rules, the secondary formula by determining the performance rate of the secondary formula based on the at least one of the user preference, the safety score, and the stability, the claim association, and the innovation index of either the at least one first ingredient or the plurality of ingredients, along with the at least one second ingredient.

9. The processor-implemented method of claim 8, wherein the method comprises refining, by the second machine learning model, the secondary formula using the if the user is not satisfied with the secondary formula that is validated or if the performance rate of the secondary formula is below the threshold level.

10. A system for automatically suggesting a formula for a product based on a user preference and a desired function using machine learning, comprising:
a formula suggesting server that obtains a plurality of ingredients with at least one desired function inputted by a user for a primary formula or at least one first ingredient selected by the user from a set of ingredients suggested by a first machine learning model for the primary formula, wherein the formula suggesting server comprises
a memory that stores a set of instructions;
a processor that executes the set of instructions and is configured to,
obtain a plurality of ingredients with at least one desired function inputted by a user associated with a user device for a primary formula or at least one first ingredient selected by the user from a set of ingredients suggested by a first machine learning model for a primary formula;
suggest, by a second machine learning model, a list of related ingredients that have a causal relationship with the primary formula, wherein the second machine learning model is trained based on causal relationships between features of historical ingredients or combinations of the historical ingredients, for a product associated with a product category;
process a selection, of at least one second ingredient from the list of related ingredients by the user, to obtain a secondary formula that comprises either the at least one first ingredient or the plurality of ingredients, along with the at least one second ingredient; and
suggest, using a third machine learning model, a concentration for the secondary formula that performs the at least one desired function for the product category, wherein the third machine learning model is trained by correlating the historical ingredients with historical concentrations and historical desired functions, thereby refining the primary formula.

11. The system of claim 10, wherein the set of ingredients is suggested by
(i) receiving, using a user device, an input from the user, wherein the input of the user comprises a product category, at least one user preference, and the at least one desired function;
(ii) determining, using the first machine-learning model, at least one primary function for the product category and suggesting the set of ingredients for the product category based on the at least one user preference and the at least one primary function, wherein the first machine learning model is trained by correlating historical products associated with historical product categories with the historical ingredients associated with the historical products based on a first set of rules; and
(iii) processing the selection of the at least one first ingredient from a set of suggested ingredients, to obtain the primary formula that comprises the at least one first ingredient.

12. The system of claim 10, wherein the processor is further configured to validate the primary formula by determining a performance rate of the primary formula based on the at least one user preference, a safety score, a stability index, a claim association, or an innovation index of the at least one first ingredient or the plurality of ingredients of the primary formula by applying a fourth set of rules on the primary formula.

13. The system of claim 10, wherein the processor is further configured to rank the list of related ingredients that are matched with the primary formula based on the causal relationship with the primary formula.

14. The system of claim 10, wherein the processor is further configured to rank the concentration of each ingredient in the secondary formula to perform the at least one desired function of the product category.

15. The system of claim 12, wherein the processor is further configured to refine, by the second machine learning model, the primary formula by suggesting the list of related ingredients if the performance rate of the primary formula is below a threshold level.

16. The system of claim 15, wherein the processor is further configured to refine, by the second machine learning model, the primary formula by suggesting the list of related ingredients if the at least one first ingredient of the primary formula is not relevant to the at least one user preference or if the user does not satisfy with the at least one first ingredient of the primary formula that is validated.

17. The system of claim 10, wherein the processor is further configured to validate, by applying the fourth set of rules, the secondary formula by determining the performance rate of the secondary formula based on the at least one of the user preference, the safety score, and the stability, the claim association, and the innovation index of either the at least one first ingredient or the plurality of ingredients, along with the at least one second ingredient.

18. The system of claim 1, wherein the processor is further configured to validate, by applying the fourth set of rules, the secondary formula by determining the performance rate of the secondary formula based on the at least one of the user preference, the safety score, and the stability, the claim association, and the innovation index of either the at least one first ingredient or the plurality of ingredients, along with the at least one second ingredient.

19. One or more non-transitory computer-readable storage mediums storing one or sequences of instructions, which when executed by one or more processors, causes a method for automatically suggesting a formula for a product based on a user preference and a desired function using machine learning, wherein the method comprises,
obtaining a plurality of ingredients with at least one desired function inputted by a user associated with a user device for a primary formula or at least one first ingredient selected by the user from a set of ingredients suggested by a first machine learning model for a primary formula;
suggesting, by a second machine learning model, a list of related ingredients that have a causal relationship with the primary formula, wherein the second machine learning model is trained based on causal relationships between features of historical ingredients or combinations of the historical ingredients using a second set of rules, for a product associated with a product category;
processing a selection, of at least one second ingredient from the list of related ingredients by the user, to obtain a secondary formula that comprises either the at least one first ingredient or the plurality of ingredients, along with the at least one second ingredient; and
suggesting, using a third machine learning model, a concentration for the secondary formula that performs the at least one desired function for the product category, wherein the third machine learning model is trained by correlating the historical ingredients with historical concentrations and historical desired functions based on a third set of rules, thereby refining the primary formula.
